(19) United States
(12) Patent Application Publication
(10) Pub. No.: US 2020/0293124 A1
(43) Pub. Date: Sep. 17, 2020

(54) PRESSURE TRIGGERED STYLUS STRUCTURE

(71) Applicant: Waltop International Corporation, Hsinchu City (TW)

(72) Inventors: YI-CHIH CHANG, Hsinchu City (TW); HUNG-I WANG, New Taipei City (TW); CHIH-HUNG HUANG, Hsinchu City (TW)

(21) Appl. No.: 16/796,315

(22) Filed: Feb. 20, 2020

(30) Foreign Application Priority Data
Mar. 14, 2019 (TW) 108108722

(51) Int. Cl. G06F 3/0354; G06F 3/038

(52) U.S. Cl. CPC G06F 3/03545; G06F 3/038

(57) ABSTRACT

A pressure triggered stylus structure including a stylus housing unit, a writing unit, an electrically conductive unit, a control unit, a first trigger unit, a second trigger unit, an elastic unit and a sensing unit is provided. When the writing unit is at an initial position and the electrically conductive unit is connected to the first trigger unit and the second trigger unit, the first trigger unit and the second trigger unit are in a connected state. On the other hand, when the writing unit is off the initial position and the electrically conductive unit is away from the first trigger unit and the second trigger unit, the first trigger unit and the second trigger unit are in a disconnected state, and the control unit detects a sensing state of the sensing unit according to the disconnected state.

### CROSS-REFERENCE TO RELATED PATENT APPLICATION

This application claims the benefit of priority to Taiwan Patent Application No. 108108722, filed on Mar. 14, 2019. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a stylus structure, and more particularly to a pressure triggered stylus structure with an activation function.

### BACKGROUND OF THE DISCLOSURE

Many methods are used to operate a touch panel, the most common one being to touch or slide a finger or a stylus on a surface of the touch panel so that a sensor inside the touch panel generates the corresponding signals. However, along with the increasing application of capacitive touch panels, a disadvantage of low accuracy in detection of capacitive touch panels would greatly reduce the smoothness of operation in some applications that may require more accurate detection performance. Therefore, many users choose to use a capacitive stylus to increase the accuracy of their touch.

In the related art, the operational design of the conventional capacitive stylus usually requires a user to press a button switch on the stylus before use in order to activate the electronic components therein, and the user may then perform operations on the touch panel.

### SUMMARY OF THE DISCLOSURE

In response to the above-referenced technical inadequacies, the present disclosure provides a pressure triggered stylus structure.

In one aspect, the present disclosure provides a pressure triggered stylus structure including a stylus housing unit, a writing unit, an electrically conductive unit, a control unit, a first trigger unit, a second trigger unit, an elastic unit and a sensing unit. The writing unit is disposed in the stylus housing unit and passes therethrough. The electrically conductive unit is sleeved on the writing unit. The control unit is located in the stylus housing unit. The first trigger unit is located in the stylus housing unit and electrically connected to the control unit. The elastic unit is sleeved on the writing unit and abuts thereagainst. The sensing unit is located between the writing unit and the control unit, and is electrically connected to the control unit. When the writing unit is at an initial position and the electrically conductive unit is connected to the first trigger unit and the second trigger unit, the first trigger unit and the second trigger unit are in a connected state. On the other hand, when the writing unit is off the initial position and the electrically conductive unit is away from the first trigger unit and the second trigger unit, the first trigger unit and the second trigger unit are in a disconnected state, and the control unit detects a sensing state of the sensing unit according to the disconnected state.

Therefore, one beneficial effect of the present disclosure is that the pressure triggered stylus structure according to the present disclosure can provide a user with convenience in operation.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a first perspective view of a pressure triggered stylus structure according to a first embodiment of the present disclosure.

FIG. 2 is a first sectional view of the pressure triggered stylus structure according to the first embodiment of the present disclosure.

FIG. 3 is an enlarged view of part III of FIG. 2.

FIG. 4 is a second sectional view of the pressure triggered stylus structure according to the first embodiment of the present disclosure.

FIG. 5 is an enlarged view of part V of FIG. 4

FIG. 6 is a functional block diagram of the pressure triggered stylus structure according to the first embodiment of the present disclosure.

FIG. 7 is a second perspective view of the pressure triggered stylus structure according to the first embodiment of the present disclosure.

FIG. 8 is a first sectional view of a pressure triggered stylus structure according to a second embodiment of the present disclosure.

FIG. 9 is a second sectional view of the pressure triggered stylus structure according to the second embodiment of the present disclosure.

FIG. 10 is a functional block diagram of a pressure triggered stylus structure according to a third embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components or the like, which are for distinguishing one component from another one only, and are not intended to, nor should be construed to impose any substantive limitations on the components or the like.

### First Embodiment

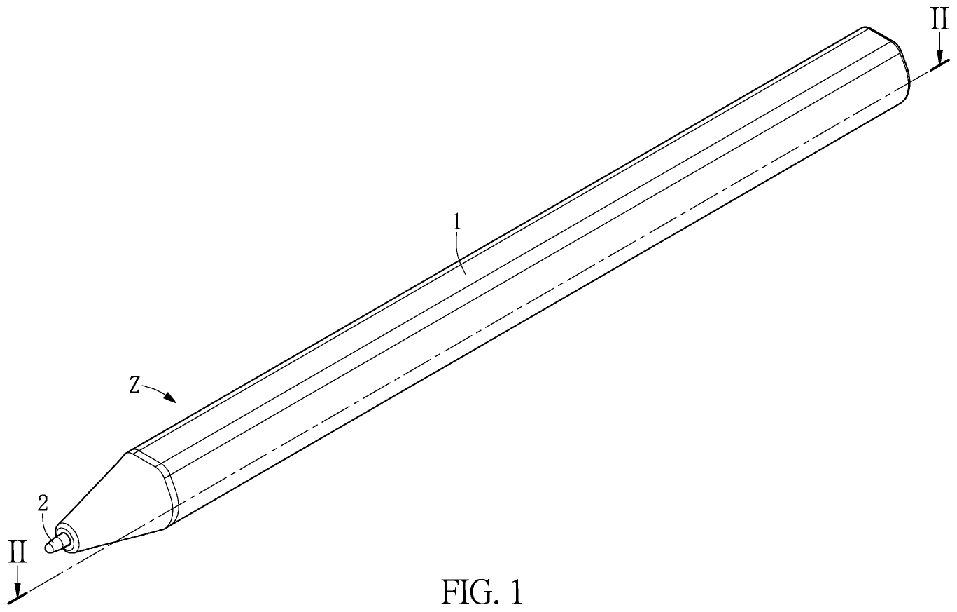

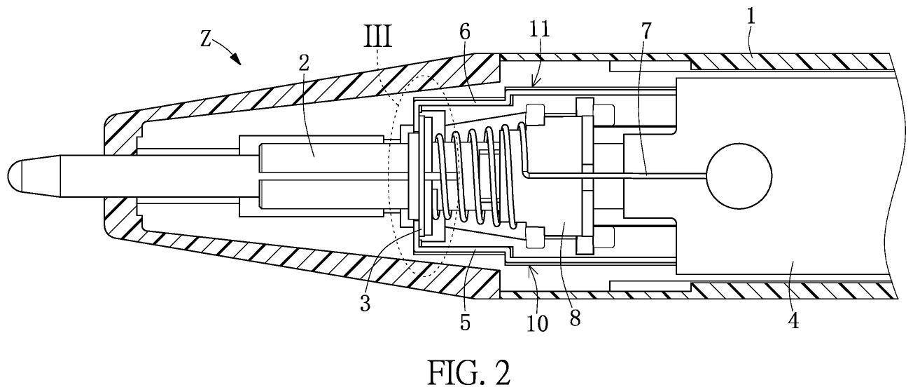

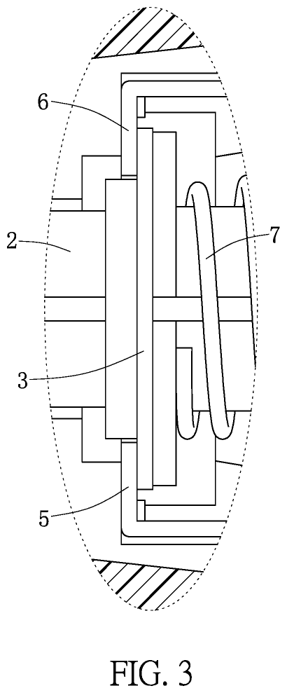

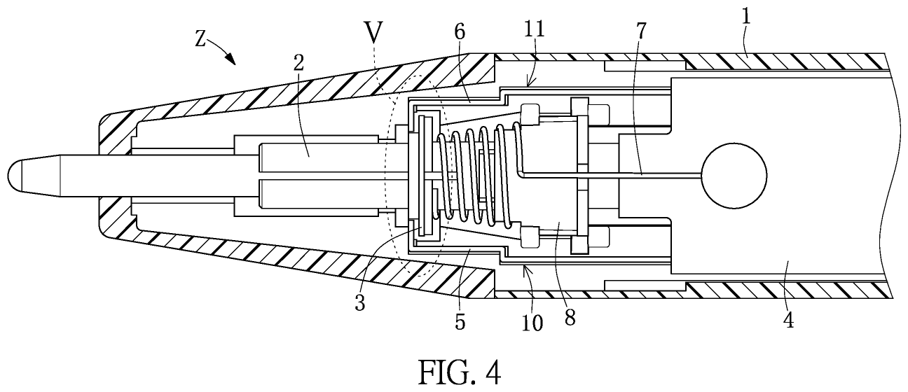

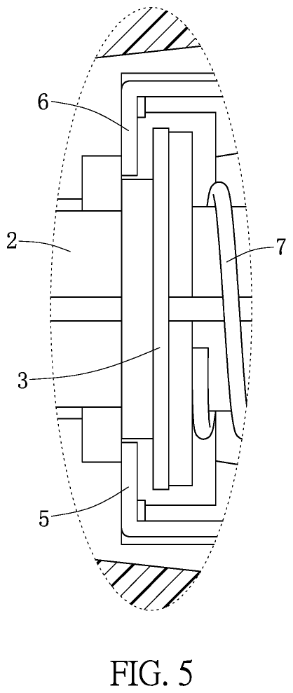

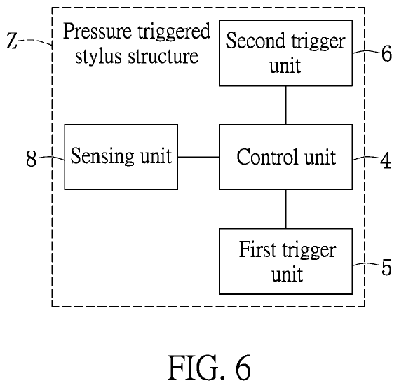

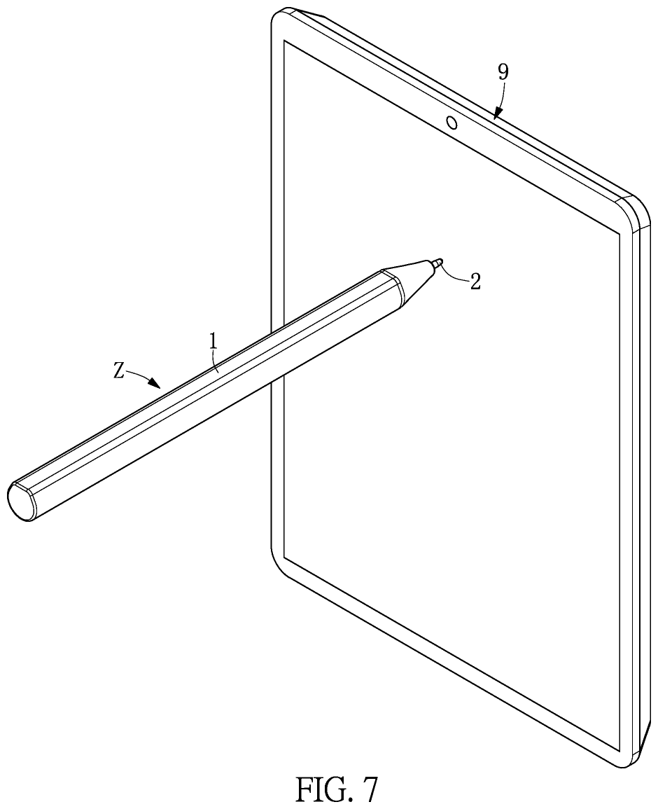

Reference is made to FIG. 1 to FIG. 7. FIG. 1, FIG. 2, FIG. 4, FIG. 6 and FIG. 7 are a first perspective view, a first sectional view, a second sectional view, a functional block diagram and a second perspective view of a pressure triggered stylus structure according to a first embodiment of the present disclosure. FIG. 3 is an enlarged view of part III of FIG. 2. FIG. 5 is an enlarged view of FIG. 4. The present embodiment provides a pressure triggered stylus structure Z including a stylus housing unit 1, a writing unit 2, an electrically conductive unit 3, a control unit 4, a first trigger unit 5, a second trigger unit 6, an elastic unit 7 and a sensing unit 8. The writing unit 2 is disposed in the stylus housing unit 1 and passes therethrough. The electrically conductive unit 3 is sleeved on the writing unit 2. The control unit 4 is located in the stylus housing unit 1. The first trigger unit 5 is located in the stylus housing unit 1 and electrically connected to the control unit 4. The elastic unit 7 is sleeved on the writing unit 2 and abuts thereagainst. The sensing unit 8 is located between the writing unit 2 and the control unit 4, and the sensing unit 8 is electrically connected to the control unit 4. When the writing unit 2 is at an initial position and the electrically conductive unit 3 is connected to the first trigger unit 5 and the second trigger unit 6, the first trigger unit 5 and the second trigger unit 6 are in a connected state. On the other hand, when the writing unit 2 is off the initial position and the electrically conductive unit 3 is away from the first trigger unit 5 and the second trigger unit 6, the first trigger unit 5 and the second trigger unit 6 are in a disconnected state, and the control unit 4 detects a sensing state of the sensing unit 8 according to the disconnected state.

Specifically, the stylus housing unit 1 can be a housing of the pressure triggered stylus structure Z, and can be made of metal or plastic. In addition, the stylus housing unit 1 can accommodate the writing unit 2, the electrically conductive unit 3, the control unit 4, the first trigger unit 5, the second trigger unit 6, the elastic unit 7 and the sensing unit 8. The writing unit 2 can be a component of a pressure triggered stylus structure Z for touching an electronic device (e.g., a tablet device 9, but not limited thereto), and is located at a front end of the stylus housing unit 1. The electrically conductive unit 3 is sleeved on the writing unit 2, and the electrically conductive unit 3 can be a hollow metal body and preferably in a ring shape, but is not limited thereto. The first trigger unit 5 and the second trigger unit 6 can be metal terminals and located in the stylus housing unit 1. One end of the first trigger unit 5 and one end of the second trigger unit 6 are electrically connected to the control unit 4, separately. In addition, a plurality of passages 10, 11 which are arranged corresponding to each other can be formed in the stylus housing unit 1, the first trigger unit 5 can be located in one of the passages 10, and the second trigger unit 6 can be located in another one of the passages 11. The elastic unit 7 can be a spring or any elastic component. The elastic unit 7 can be sleeved on the writing unit 2, in which an end of the elastic unit 7 can abut against the writing unit 2, and another end of the elastic unit 7 can abut against an inner wall of the stylus housing unit 1 or the sensing unit 8. Further, the sensing unit 8 can be located between the writing unit 2 and the control unit 4, and the sensing unit 8 is electrically connected to the control unit 4. Furthermore, the sensing unit 8 can be a pressure sensor for sensing different levels of pressure, but is not limited thereto. The sensing unit 8 can be a sensor of other types as well.

Therefore, when the pressure triggered stylus structure Z of the present disclosure is in an unused state, the elastic unit 7 presses against the writing unit 2 with its elastic restoring force, so that the writing unit 2 is located at an initial position (as shown in FIG. 2 and FIG. 3). In addition, when the writing unit 2 is at the initial position, the electrically conductive unit 3 can be in contacted with the first trigger unit 5 and the second trigger unit 6, such that the first trigger unit 5 and the second trigger unit 6 can be electrically connected to each other through the electrically conductive unit 3 so as to be in a connected state. Further, the control unit 4 will determine that the pressure triggered stylus structure Z is in the unused state according to the connected state, and therefore the control unit 4 will not drive the sensing unit 8 to operate or detect the sensing state of the sensing unit 8.

When a user wishes to operate the tablet device 9 with the pressure triggered stylus structure Z, the user can directly touch the tablet device 9 with the pressure triggered stylus structure Z. At this time, since the writing unit 2 of the pressure triggered stylus structure Z is used to touch the tablet device 9, a reaction force is generated to move the writing unit 2 away from the initial position (as shown in FIG. 4 and FIG. 5). The writing unit 2 is displaced toward the interior of the stylus housing unit 1 (i.e., toward the sensing unit 8), such that the elastic unit 7 is in a compressed state. Further, the conductive unit 3 is disengaged from the contact between the first trigger unit 5 and the second trigger unit 6 due to the displacement of the writing unit, so that the first trigger unit 5 and the second trigger unit 6 are no longer electrically connected to each other and are therefore in a disconnected state. Furthermore, according to the disconnected state, the control unit 4 drives the sensing unit 8 to operate or detects the sensing state of the sensing unit 8, and the control unit 4 sends a signal to the tablet device 9 according to a sensing result of the sensing unit 8 to operate the tablet device 9.

Therefore, through the foregoing aspects, the pressure triggered stylus structure Z disclosed in the present disclosure can be provided without a button switch, such that the user can directly use the stylus without the step of pressing the button switch during operation, thereby providing convenience in operation.

Furthermore, according to the connected state, the control unit 4 can perform a counting action, and the control unit 4 will be switched to an inactive state from an active state when the counting action is done. In addition, according to the disconnected state, the control unit 4 can be switched to the active state from the inactive state and detect the sensing state of the sensing unit.

For instance, during or after using the pressure triggered stylus structure Z, when the writing unit 2 does not touch any object, the elastic unit 7 can press against the writing unit 2 with its elastic restoring force to return the writing unit 2 to the initial position (as shown in FIG. 2 and FIG. 3). At this time, the electrically conductive unit 3 is in contact with the first trigger unit 5 and the second trigger unit 6 again, such that the first trigger unit 5 and the second trigger unit 6 are in the connected state. In addition, according to the connected state, the control unit 4 can perform the counting action, e.g., a 5-second countdown, but is not limited thereto. After the counting action is done, the control unit 4 will be switched to the inactive state from the active state, and the electronic components inside the pressure triggered stylus structure will also stop working.

On the other hand, when the writing unit 2 leaves the initial position (as shown in FIG. 4 and FIG. 5) from touching an object or receiving an external force, the first trigger unit 5 and the second trigger unit 6 are no longer electrically connected to each other and are therefore in the disconnected state. At this time, according to the disconnected state, the control unit 4 will be switched to the active state from the inactive state and detects the sensing state of the sensing unit 8.

Furthermore, when the writing unit 2 is off the initial position and abuts against the sensing unit 8, the sensing unit 8 generates at least one sensing signal, and the control unit 4 generates a touch control signal according to at least one sensing signal. For instance, when the writing unit 2 touches the tablet device 9 and thus leaves the initial position (as shown in FIG. 4 and FIG. 5) to abut against the sensing unit 8, the sensing unit 8 can generate at least one sensing signal correspondingly. In addition, according to at least one sensing signal, the control unit 4 can generate the touch control signal and send it to the tablet device 9 for operation thereof.

### Second Embodiment

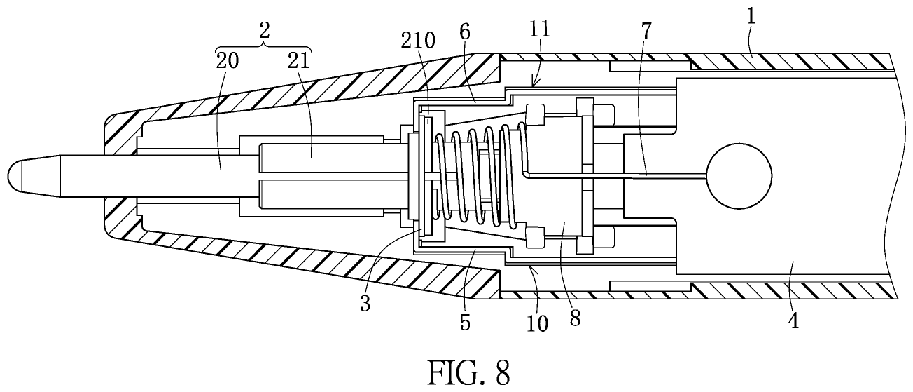

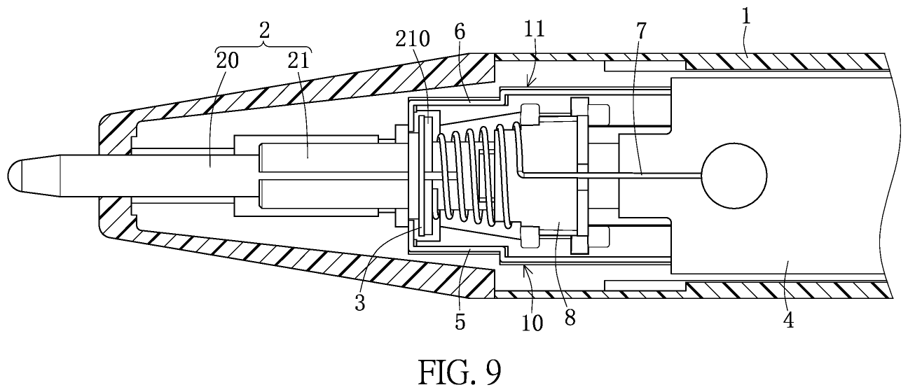

Reference is made to FIG. 8 and FIG. 9, which are a first sectional view and a second sectional view of a pressure triggered stylus structure according a second embodiment of the present disclosure, and are to be read in conjunction with FIG. 1 to FIG. 7. In the pressure triggered stylus structure Z according to the present embodiment, the working principles of the same components and those of the pressure triggered stylus structure Z of the first embodiment are similar, and descriptions thereof will be omitted herein. It should be noted that, in the present embodiment, the writing unit 2 includes a stylus core component 20 and a stylus holder component 21. The stylus core component 20 is disposed in the stylus housing unit 1 and passes therethrough, and the stylus holder component 21 is sleeved on the stylus core component 20. The stylus holder component 21 is located in the stylus housing unit 1, and the electrically conductive unit 3 is sleeved on the stylus holder component 21.

For instance, the stylus core component 20 passes through the front end of the stylus housing unit 1 and the stylus holder component 21. An outer edge of the stylus holder component 21 protrudes outward to form a ring-shaped protruding part 210, and the electrically conductive unit 3 is sleeved on the stylus holder component 21 and adjacent to the protruding part 210. The elastic unit 7 is sleeved on the stylus holder component 21 and located between the protruding part 210 and the sensing unit 8. The end of the elastic unit 7 abuts against the protruding part 210.

Therefore, when the pressure triggered stylus structure Z is in the unused state or does not touch any object, the elastic unit 7 presses against the protruding part 210 by its elastic restoring force so that the stylus holder component 21 is located at the initial position (as shown in FIG. 8). In addition, when the stylus holder component 21 is at the initial position, the electrically conductive unit 3 can be in contact with the first trigger unit 5 and the second trigger unit 6, such that the first trigger unit 5 and the second trigger unit 6 can be electrically connected to each other to be in the connected state.

On the other hand, when the pressure triggered stylus structure Z is used to touch the object (e.g., tablet device 9), a reaction force is generated to move the stylus core component 20 toward the interior of the stylus housing unit 1 and further drives the stylus holder component 21 toward the sensing unit 8. At this time, the stylus holder component 21 will leave the initial position (as shown in FIG. 9), so that the conductive unit 3 is disengaged from the contact between the first trigger unit 5 and the second trigger unit 6. Therefore, the first trigger unit 5 and the second trigger unit 6 are no longer electrically connected to each other and are therefore in the disconnected state.

Furthermore, when the stylus holder component 21 is off the initial position and abuts against the sensing unit 8, the sensing unit 8 will generate at least one sensing signal that corresponds to the pressure applied by the stylus holder component 21. For instance, according to the disconnected state, the control unit 4 will be switched to the active state from the inactive state and detects the sensing state of the sensing unit 8. Therefore, after the sensing unit 8 is touched by the stylus holder component 21 and correspondingly generates at least one sensing signal, the control unit 4 can correspondingly generate the touch control signal according to the at least one sensing signal and send it to the tablet device 9.

### Third Embodiment

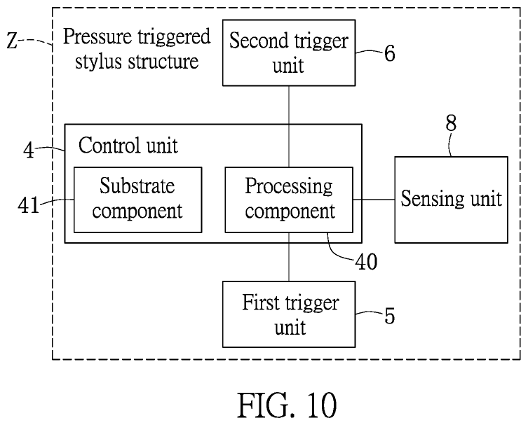

Reference is made to FIG. 10, which is a functional block diagram of a pressure triggered stylus structure according to a third embodiment of the present disclosure, and is to be read in conjunction with FIG. 1 to FIG. 9. In the pressure triggered stylus structure Z according to the present embodiment, the operation mechanisms of the same components and those of the pressure triggered stylus structure Z of the above-mentioned embodiments are similar, and descriptions thereof will be omitted herein. It should be noted that, in the present embodiment, the control unit 4 includes a processing component 40 and a substrate component 41 electrically connected to the processing component 40. The substrate component 41 is located in the stylus housing unit 1 and electrically connected to the first trigger unit 5, the second trigger unit 6 and the sensing unit 8. One end of the elastic unit 7 is connected to the substrate 41.

For instance, the processing component 40 can be a microcontroller unit (MCU) or another processor having control and processing functions, and the substrate component 41 can be a circuit board, but is not limited thereto. The processing component 40 can be disposed on the substrate component 41 and electrically connected to the first trigger unit 5, the second trigger unit 6 and the sensing unit 8.

However, the above-mentioned embodiments are merely certain practicable embodiments, and are not intended to limit the scope of the present disclosure.

### Beneficial Effects of Embodiments

In conclusion, one beneficial effect of the present disclosure is that the pressure triggered stylus structure provided in the present disclosure can provide the user with convenience in operation by virtue of the foregoing features.

Furthermore, a conventional capacitive stylus requires the user to press the button switch on the stylus to activate the stylus for the subsequent operation. In contrast, the pressure triggered stylus structure Z, through the forgoing features (that is, the structural design and configuration of a writing unit 2, an electrically conductive unit3, a control unit 4, a first trigger unit 5, a second trigger unit 6 and an elastic unit 7), can automatically be in an inactive state when not in use to achieve an effect of reducing energy consumption. In addition, when the user wishes to use the pressure triggered stylus structure Z, the user is not required to press any button or switch and may directly use the stylus, thereby providing the user with convenience in operation.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A pressure triggered stylus structure, comprising:
a stylus housing unit;
a writing unit disposed in the stylus housing unit and passing therethrough;
an electrically conductive unit sleeved on the writing unit;
a control unit disposed in the stylus housing unit;
a first trigger unit located in the stylus housing unit and electrically connected to the control unit;
a second trigger unit located in the stylus housing unit and electrically connected to the control unit;
an elastic unit sleeved on the writing unit and abutting thereagainst; and
a sensing unit located between the writing unit and the control unit and electrically connected to the control unit;
wherein when the writing unit is at an initial position and the electrically conductive unit is connected to the first trigger unit and the second trigger unit, the first trigger unit and the second trigger unit are in a connected state, and wherein when the writing unit is off the initial position and the electrically conductive unit is away from the first trigger unit and the second trigger unit, the first trigger unit and the second trigger unit are in a disconnected state, and the control unit detects a sensing state of the sensing unit according to the disconnected state.

2. The pressure triggered stylus structure according to claim 1, wherein the control unit performs a counting action according to the connected state, and the control unit is switched to an inactive state from an active state when the counting action is done.

3. The pressure triggered stylus structure according to claim 2, wherein according to the disconnected state, the control unit is switched to the active state from the inactive state and detects the sensing state of the sensing unit.

4. The pressure triggered stylus structure according to claim 1, wherein when the writing unit is off the initial position and abuts against the sensing unit, the sensing unit generates at least one sensing signal, and the control unit generates a touch control signal according to the at least one sensing signal.

5. The pressure triggered stylus structure according to claim 4, wherein the writing unit includes a stylus core component disposed in the stylus housing unit and passes therethrough and a stylus holder component sleeved on the stylus core component, and wherein the stylus holder component is located in the stylus housing unit, and the electrically conductive unit is sleeved on the stylus holder component.

6. The pressure triggered stylus structure according to claim 5, wherein the elastic unit abuts against the stylus holder component to position the stylus holder component to the initial position, and the electrically conductive unit is connected to the first trigger unit and the second trigger unit.

7. The pressure triggered stylus structure according to claim 5, wherein the stylus core component receives a force to push against the stylus holder component, so that the stylus holder component moves off the initial position, and the electrically conductive unit moves away from the first trigger unit and the second trigger unit.

8. The pressure triggered stylus structure according to claim 7, wherein when the stylus holder component is off the initial position and abuts against the sensing unit, the sensing unit generates the at least one sensing signal.

9. The pressure triggered stylus structure according to claim 1, wherein a plurality of passages are arranged corresponding to each other in the stylus housing unit, the first trigger unit is located in one of the passages, and the second trigger unit is located in another one of the passages.

10. The pressure triggered stylus structure according to claim 1, wherein the control unit includes a processing component and a substrate component electrically connected to the processing component, and the substrate component is located in the stylus housing unit and electrically connected to the first trigger unit, the second trigger unit and the sensing unit.
